(19) United States
(12) Patent Application Publication
(10) Pub. No.: US 2015/0265010 A1
(43) Pub. Date: Sep. 24, 2015

(54) JEWELRY RING DISPLAY APPARATUS AND ASSOCIATED METHODS

(71) Applicant: Cloud Displays LLC, Sanford, FL (US)

(72) Inventors: Louie Edwards, Sanford, FL (US); Austin Lee Bobbie Kaplan, Apopka, FL (US)

(73) Assignee: Cloud Displays LLC, Sanford, FL (US)

(21) Appl. No.: 14/221,727

(22) Filed: Mar. 21, 2014

(51) Int. Cl. A44C 9/00; F16M 11/22; F16M 11/04

(52) U.S. Cl. CPC A44C 9/0084; F16M 11/04; F16M 11/22

(57) ABSTRACT

A jewelry ring display apparatus includes a platform having upper and lower surfaces with an opening extending therebetween. A first end line attachment is on the lower surface, and a second end line attachment is on the lower surface and positioned so that the opening is between the first and second end line attachments. A line has a first end to be held by the first end line attachment, and a second end to be passed through the opening and inserted through and around a ring to be displayed on the upper surface. The second end of the line is to be passed back through the opening and is to be held by the second end line attachment. The line is under tension when extending between the first and second end line attachments so that the ring can be held in a stationary position with respect to the upper surface of the platform.

### FIELD OF THE INVENTION

The present invention relates to the field of jewelry photography, and more particularly, to a jewelry ring display to be used during jewelry photography and related methods.

### BACKGROUND OF THE INVENTION

Jewelry rings are one of the hardest jewelry products to photograph because of the nature of its components. The metals, precious stones, diamonds and other elements that most fine jewelry rings are made up of have reflective qualities that can easily show reflections, shadows and hard spots in photographs if the right tools are not used.

Positioning a jewelry ring correctly is essential for getting a professional photograph. When customers look at photographs of a jewelry ring, they tend to judge the photographs more so than the actual jewelry ring. Consequently, it is desirable to take the best photographs possible. Taking photographs from the correct angles and perspectives is key to successful shots.

One approach for positioning a jewelry ring is to use a pyramid ring stands which holds the ring at a 45 degree angle. A pyramid ring stand comes in black, white and transparent. A drawback of the pyramid ring stand is that it remains at least partially visible in the photograph, and the ring remains at the 45 degree angle.

Another approach for positioning a jewelry ring is to use wax so as to make the ring appear as if it is floating. A specially manufactured wax allows a jewelry ring to be positioned in an upright vertical position or at various angles. The wax is hard and resistant, yet flexible enough for it to be handled and molded to hold a jewelry ring in a desired position. While effective, there are a couple of drawbacks of using wax to hold a ring in a desired position. One drawback is that the wax may be visible in the photograph. Another drawback is that the jewelry ring needs to be cleaned after the wax has been removed.

### SUMMARY OF THE INVENTION

In view of the foregoing background, it is therefore an object of the present invention to provide an apparatus that easily allows a ring to be positioned so as to be photographed.

This and other objects, features, and advantages in accordance with the present invention are provided by a jewelry ring display apparatus comprising a platform having spaced apart upper and lower surfaces with an opening extending therebetween, a first end line attachment on the lower surface of the platform, and a second end line attachment also on the lower surface of the platform and positioned so that the opening is between the first and second end line attachments.

A line having a first end is to be held by the first end line attachment. A second end of the line is to be passed through the opening and inserted through and around a ring to be displayed on the upper surface, with the second end to be passed back through the opening and to be held by the second end line attachment. The line is under tension when extending between the first and second end line attachments so that the ring is held in a stationary position with respect to the upper surface of the platform.

A tensioner pin may be coupled to the second end of the line, and the second end line attachment may include at least one opening for receiving the tensioner pin. The at least one opening for receiving the tensioner pin may include a plurality of spaced apart openings, with each opening allowing for adjustment in the tension of the line.

The first end of the line may be configured as a lasso so as to be slipped over the first end line attachment. The opening in the platform may be in a center portion thereof. The line may be a monofilament line, thread or wire, for example. The platform may be circular shaped with a non-reflective surface.

Another aspect of the present invention is directed to a method for displaying a ring using the jewelry ring display apparatus as discussed above. The method comprises providing a line having first and second ends, securing the first end of the line to the first end line attachment, and passing the second end of the line through the opening in the platform. The method further comprises inserting the second end of the line through and around the ring to be displayed on the upper surface of the platform. The second end of the line is passed back through the opening. The second end of the line may then be secured to the second end line attachment. The line is under tension when extending between the first and second end line attachments so that the ring is held in a stationary position with respect to the upper surface of the platform.

### BRIEF DESCRIPTION OF THE DRAWINGS

FIG. 1 is a perspective view of a jewelry ring display apparatus holding a ring in a stationary position in accordance with the present invention.

FIG. 2 is a side view of the jewelry ring display apparatus illustrated in FIG. 1.

FIG. 3 is a bottom view of the jewelry ring display apparatus illustrated in FIG. 1.

FIG. 4 is a cross-sectional side view of a center portion of the jewelry ring display apparatus illustrated in FIG. 1.

FIG. 5 is a perspective view of the line and tensioner pin from FIG. 1.

FIG. 6 is a perspective view of another embodiment of the first end of the line and the first end line attachment from FIG. 1.

FIG. 7 is a side view of another embodiment of the jewelry ring display apparatus in accordance with the present invention.

FIG. 8 is a flowchart illustrating a method for displaying a ring using the jewelry ring display apparatus illustrated in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notations are used to indicate similar elements in alternative embodiments.

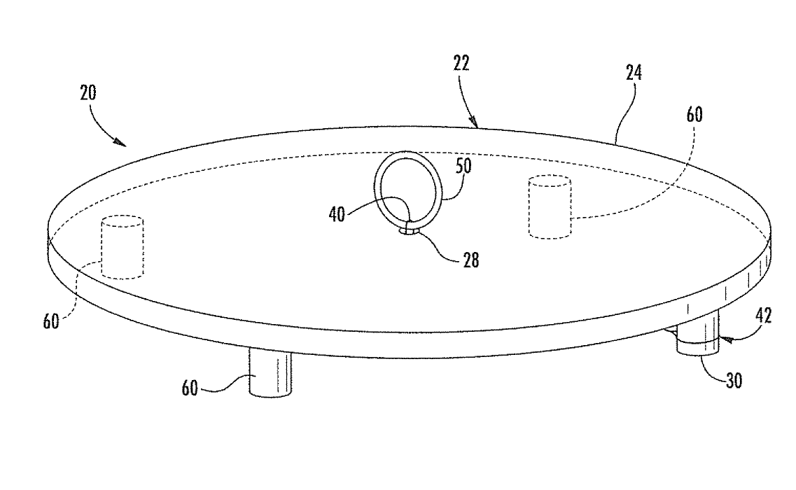

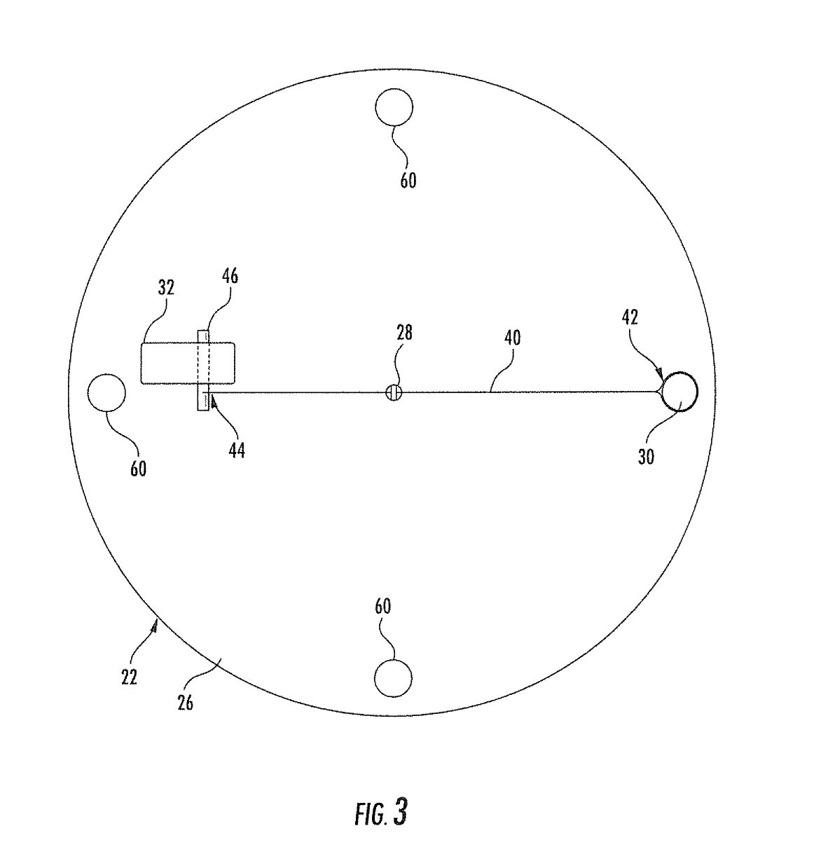

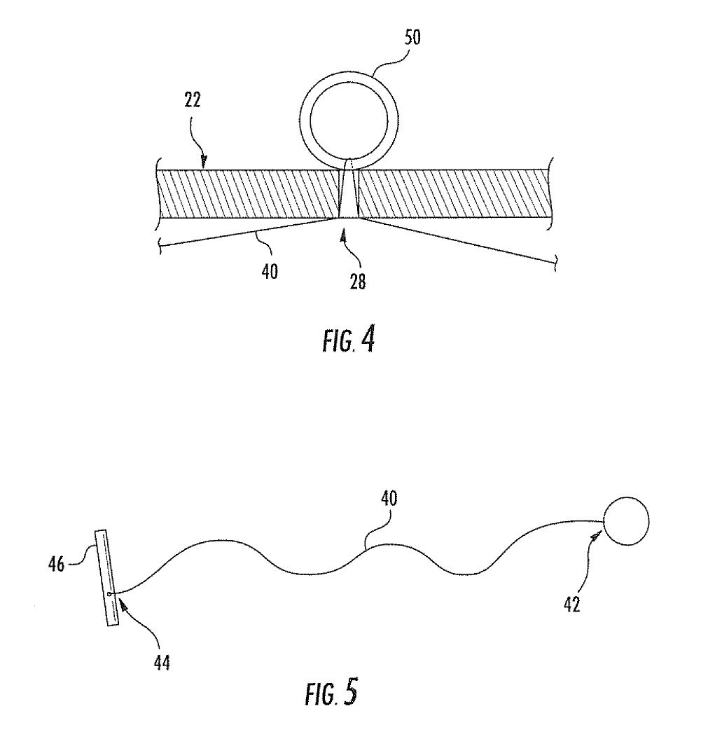

Referring initially to FIGS. 1-5, a jewelry ring display apparatus 20 comprises a platform 22 having spaced apart upper and lower surfaces 24, 26 with an opening 28 extending therebetween. A first end line attachment 30 is on the lower surface 26 of the platform 22. A second end line attachment 32 is also on the lower surface 26 of the platform 22 and is positioned so that the opening 28 is between the first and second end line attachments 30, 32.

A line 40 having a first end 42 is to be held by the first end line attachment 30, and a second end 44 of the line is to be passed through the opening 28 and inserted through and around a ring 50 to be displayed on the upper surface 24. The second end 44 of the line 40 is then passed back through the opening 28, and is to be held by the second end line attachment 32. The line 40 is under tension when extending between the first and second end line attachments 30, 32 so that the ring 50 can be held in a stationary position with respect to the upper surface 24 of the platform 22.

The jewelry ring display apparatus 20 advantageously holds the ring 50 in a vertical or tilted position without the use of a pyramid ring stand or specially manufactured wax, as illustrated in FIG. 1. A jewelry photographer is able to take photographs of the jewelry ring 50 at desired angles and perspectives. The ring 50 can be repositioned as desired while the line 40 is under tension. Since customers tend to judge the photographs more so than the actual jewelry ring, it is desirable to take the best photographs possible.

The jewelry ring display apparatus 20 is not limited to photographic purposes. The jewelry ring display apparatus 20 may also be used in a jewelry or department store for displaying a jewelry ring 50 to customers, for example. Even though the jewelry ring display apparatus 20 is directed to jewelry rings 50, other types of circular-shaped jewelry and objects may be held in a stationary position for display.

The illustrated platform 22 is circular-shaped with about a 16 inch diameter. The opening 28 is in a center portion of the circular-shaped platform 22. The opening 28 may also have beveled sides to assist with passing the line 40 therethrough. However, the platform 22 can be other shapes and sizes depending on the photography conditions, and the opening 28 may be centered or off-centered, as readily appreciated by those skilled in the art.

The platform 22 may have a non-reflective surface. For example, the platform 22 may have a black or white felt surface. Nonetheless, in other embodiments, the platform 22 may be formed out of glass so as to have a reflective mirrored surface. The orientation of the platform 22 is illustrated as being horizontal. In other embodiments, the platform 22 may be tilted or angled. The platform 22 includes a plurality of legs 30 coupled to the lower surface 26 thereof. The first line attachment 30 is configured as a leg. In other embodiments, the first line attachment 30 does not function as a leg.

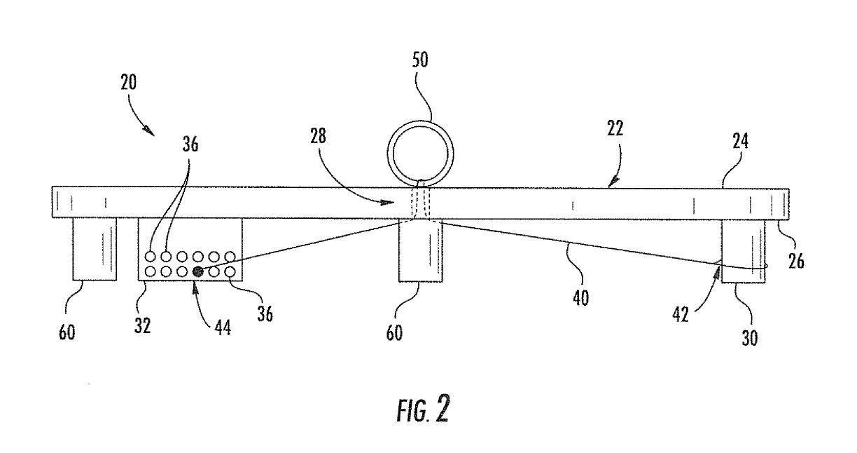

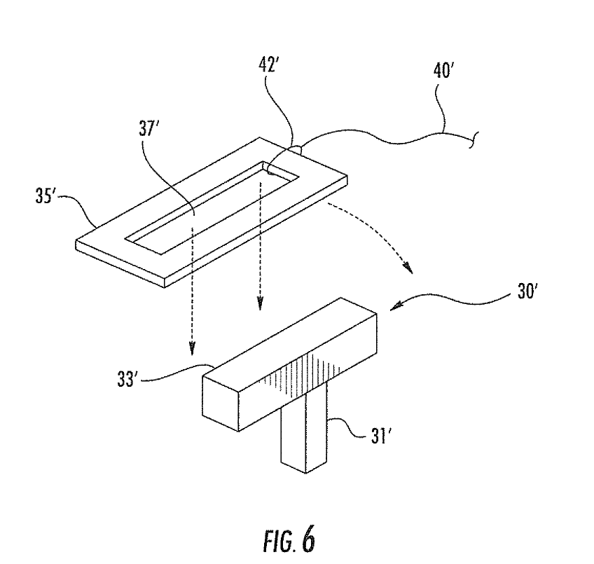

There are a number of different ways to secure the second end 44 of the line 40 so that the line remains under tension. In the illustrated embodiment, a tensioner pin 46 is coupled to the second end 44 of the line 40, as illustrated in FIG. 5. The second end line attachment 32 includes a plurality of openings 36 for receiving the tensioner pin 46. After the first end 42 of the line 40 has been secured to the first end line attachment 30 and the tensioner pin 46 and the second end 44 of the line have been inserted through and around the ring 50, then the tensioner pin 46 is inserted in one of the openings 36 in the second end line attachment 32. As best illustrated in FIG. 2, this causes the line 40 to be under enough tension so that the ring 50 is held in a stationary position with respect to the upper surface 24 of the platform 22.

The first end 42 of the line 40 is configured as a lasso, as illustrated in FIG. 5. The lasso is sized to loosely fit over the first end line attachment 30. As with the second end 44 of the line, there are a number of different ways to secure the first end 42 of the line 40 to the first end line attachment 30. For example, the first end 42 of the line 40 may have a knot instead of a lasso, and the first end line attachment 30 may include a slit to receive the knot.

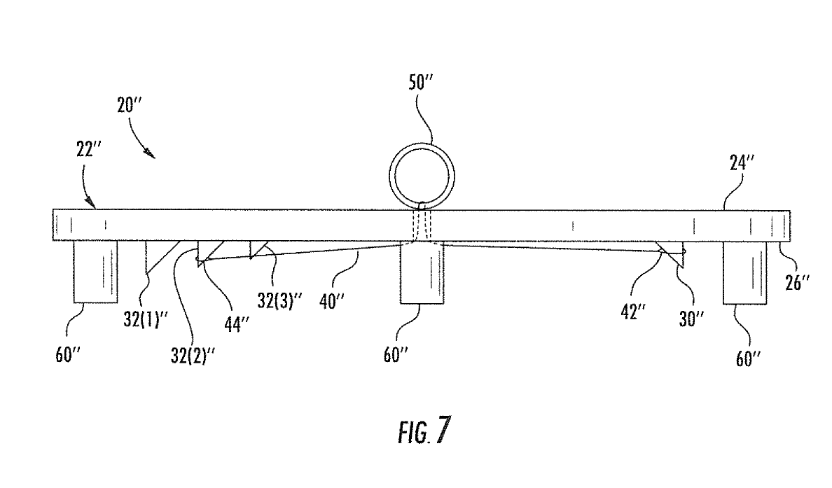

Yet another embodiment of the first end line attachment 30′ and the first end 42′ of the line 40′ is based on an interlocking arrangement, as illustrated in FIG. 6. The first end line attachment 30′ is configured as a T-shaped structure. The T-shaped structure includes a vertical component 31′ and a horizontal component 33′ coupled to the vertical component 31′. Attached to the first end 42′ of the line 40′ is a slip lock component 35′ with an opening 37′ sized to match the horizontal component 33′ of the T-shaped structure. As the arrows indicate in the figure, the slip lock component 35′ is positioned so that the opening 37′ aligns with the horizontal component 33′. The slip lock component 35′ is dropped so that it is adjacent the vertical component 31′, and then it is twisted so that the opening 37′ is perpendicular to the horizontal component 33′.

The line 40 is a monofilament line, which is also referred to as a monofilament fishing line. A monofilament line is a fishing line made from a single fiber of plastic. Other alternatives for a line 40 may be used, such as thread or wire, for example.

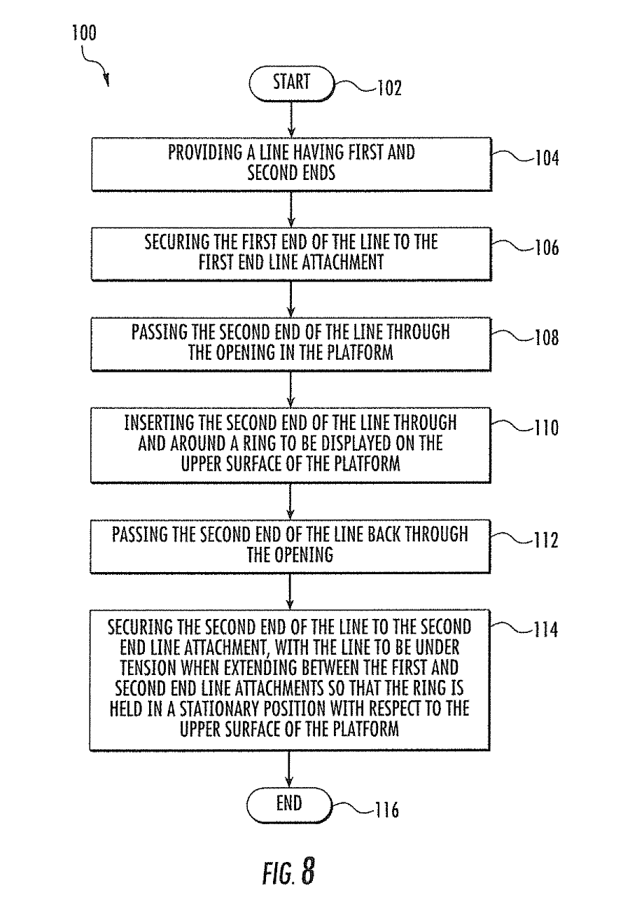

Referring now FIG. 7, another embodiment of the jewelry ring display apparatus 20″ will be discussed. In particular, the first end line attachment 30″ is not configured as a leg 60″ for the platform 22″. It is separate from the legs 60″.

Also, the first end line attachment 30″ has a triangular shape for receiving the first end 42″ of the line, which is configured as a lasso. The second end line attachment 32″ includes a plurality of triangular shaped spaced apart items 32(1)″-32(3)″ for receiving the second end 44″ of the line 40″. The second end 44″ of the line 40″ is also configured as a lasso. Depending on the length of the line 40″ and the needed tension, the send end 44″ of the line 40″ is slipped over one of the triangular shaped items 32(2)″. Even though the first and second end line attachments 30″ and 32(1)″-32(3)″ are triangular shaped, other configurations may be used to secure the first and second ends 42″, 44″ of the line 40″, as readily appreciated by those skilled in the art.

Another aspect of the present invention is directed to a method for displaying a ring 50 using the jewelry ring display apparatus 20 as discussed above. Referring now to the flowchart 100 in FIG. 8, the method comprises from the start (Block 102), providing a line 40 having first and second ends 42, 44 at Block 104. The first end 42 of the line 40 is secured at Block 106 to the first end line attachment 30. The second end 44 of the line 40 is passed through the opening 28 in the platform 22 at Block 108. The method further comprises inserting at Block 110 the second end 44 of the line 40 through and around the ring 50 to be displayed on the upper surface 24 of the platform 22. The second end 44 of the line 40 is passed back through the opening 28 at Block 112. The second end 44 of the line 40 is secured to the second end line attachment 32 at Block 114. The line is under tension when extending between the first and second end line attachments 30, 32 so that the ring 50 is held in a stationary position with respect to the upper surface of the platform. The method ends at Block 116.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A jewelry ring display apparatus comprising:
a platform having spaced apart upper and lower surfaces with an opening extending therebetween;
a first end line attachment on the lower surface of said platform;
a second end line attachment on the lower surface of said platform and positioned so that the opening is between said first and second end line attachments; and
a line having a first end to be held by said first end line attachment, and a second end to be passed through the opening and inserted through and around a ring to be displayed on the upper surface, with the second end to be passed back through the opening and to be held by said second end line attachment;
said line to be under tension when extending between said first and second end line attachments so that the ring is held in a stationary position with respect to the upper surface of said platform.

2. The jewelry ring display according to claim 1, further comprising a tensioner pin coupled to the second end of said line; and wherein said second end line attachment includes at least one opening for receiving said tensioner pin.

3. The jewelry ring display according to claim 2, wherein the at least one opening for receiving said tensioner pin includes a plurality of spaced apart openings, with each opening allowing for adjustment of the tension of said line.

4. The jewelry ring display according to claim 1, wherein the first end of said line is configured as a lasso so as to be slipped over said first end line attachment.

5. The jewelry ring display according to claim 1, further comprising a plurality of legs coupled to the lower surface of said platform.

6. The jewelry ring display according to claim 5, wherein said first end line attachment is configured as a leg.

7. The jewelry ring display according to claim 1, wherein the opening in said platform is in a center portion thereof.

8. The jewelry ring display according to claim 1, wherein said line comprises at least one of a monofilament line, thread and wire.

9. The jewelry ring display according to claim 1, wherein said platform is circular shaped.

10. The jewelry ring display according to claim 1, wherein said platform comprises a non-reflective surface.

11. A method for displaying a ring using a jewelry ring display apparatus comprising a platform having spaced apart upper and lower surfaces with an opening extending therebetween, a first end line attachment on the lower surface of the platform, a second end line attachment on the lower surface of the platform and positioned so that the opening is between the first and second end line attachments, the method comprising:
providing a line having first and second ends;
securing the first end of the line to the first end line attachment;
passing the second end of the line through the opening in the platform;
inserting the second end of the line through and around the ring to be displayed on the upper surface of the platform;
passing the second end of the line back through the opening; and
securing the second end of the line to the second end line attachment, with the line to be under tension when extending between the first and second end line attachments so that the ring is held in a stationary position with respect to the upper surface of the platform.

12. The method according to claim 11, wherein the jewelry ring display apparatus further comprises a tensioner pin coupled to the second end of the line, and the second end line attachment includes at least one opening for receiving the tensioner pin; and wherein securing the second end of the line comprises inserting the tensioner pin into the at least one opening.

13. The method according to claim 12, wherein the at least one opening for receiving the tensioner pin includes a plurality of spaced apart openings, with each opening allowing for adjustment of the tension of the line.

14. The method according to claim 11, wherein the first end of the line is configured as a lasso; and wherein securing the first end of the line comprises slipping the lasso over the first end line attachment.

15. The method according to claim 11, wherein the jewelry ring display further comprises a plurality of legs coupled to the lower surface of the platform.

16. The method according to claim 15, wherein the first end line attachment is configured as one of the plurality of legs.

17. The method according to claim 11, wherein the opening in the platform is in a center portion thereof.

18. The method according to claim 11, wherein the line comprises at least one of a monofilament line, thread and wire.

19. The method according to claim 11, wherein the platform is circular shaped.

20. The method according to claim 10, wherein the platform comprises a non-reflective surface.
